(19) United States
(12) Patent Application Publication
(10) Pub. No.: US 2026/0044349 A1
(43) Pub. Date: Feb. 12, 2026

(54) IDENTIFICATION OF PREDICTION IDENTIFIERS

(71) Applicant: Arm Limited, Cambridge (GB)

(72) Inventors: Ugo Castorina, Biot (FR); Damien Matthieu Valentin Cathrine, Mougins (FR); Gabriele Calianno, Antibes (FR); Orestis Chiotakis, Nice (FR)

(73) Assignee: Arm Limited, Cambridge (GB)

(21) Appl. No.: 18/829,823

(22) Filed: Sep. 10, 2024

(30) Foreign Application Priority Data
Aug. 9, 2024 (EP) 24386096.2

(51) Int. Cl. G06F 9/38; G06F 9/30

(52) U.S. Cl. CPC G06F 9/3844; G06F 9/3004; G06F 9/30065; G06F 9/3804

(57) ABSTRACT

There is provided an apparatus comprising prediction storage circuitry to store prediction entries. Each of the prediction entries is identified by a prediction identifier and comprises prediction information. The apparatus is provided with prediction circuitry responsive to receipt of a given prediction identifier to perform a lookup in the prediction storage circuitry. The prediction circuitry is configured, when the lookup results in a hit to retrieve corresponding prediction information and to trigger a transaction request. In further response to the hit, the prediction circuitry is also configured to perform a recursion procedure to determine whether the prediction information identifies further prediction identifiers, and if so, to trigger further lookups based on each of the further prediction identifiers. The prediction entries encode prediction confidence information, and the prediction circuitry is configured to suppress the recursion procedure when the prediction confidence information does not satisfy a recursive prediction condition.

### CROSS-REFERENCE TO RELATED APPLICATION

This application claims priority to, and the benefit of, International Patent Application EP24386096.2 filed Aug. 9, 2024, which is hereby incorporated by reference in its entirety.

### TECHNICAL FIELD

The present invention relates to data processing. More particularly the present invention relates to an apparatus, a system, a chip containing product, a method, and a non-transitory computer-readable medium.

### BACKGROUND

Some apparatuses are provided with prediction storage circuitry to store prediction entries identified by a prediction identifier. The prediction entries may include prediction information. The apparatuses may also be provided with prediction circuitry responsive to receipt of a prediction identifier to perform a lookup in the prediction storage circuitry and, in response to a hit in the prediction storage circuitry, to trigger a transaction request based on the prediction.

### SUMMARY

According to a first aspect of the present techniques there is provided an apparatus comprising:
prediction storage circuitry configured to store one or more prediction entries, each of the one or more prediction entries identified by a prediction identifier and comprising prediction information; and
prediction circuitry responsive to receipt of a given prediction identifier to perform a lookup in the prediction storage circuitry based on the given prediction identifier, wherein the prediction circuitry is configured, when the lookup results in a hit on a prediction entry of the one or more prediction entries:
   to retrieve corresponding prediction information comprised in the prediction entry and to trigger a transaction request based on the corresponding prediction information;
   to perform a recursion procedure to determine whether the prediction information identifies one or more further prediction identifiers; and
   in response to the recursion procedure determining that the prediction information identifies one or more further prediction identifiers, to trigger one or more further lookups in the prediction storage circuitry based on each of the one or more further prediction identifiers comprised in the prediction entry, wherein:
each of the one or more prediction entries encodes prediction confidence information; and
the prediction circuitry is configured to suppress the recursion procedure when the prediction confidence information encoded in the prediction entry does not satisfy a recursive prediction condition.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method comprising:
storing, in prediction storage circuitry, one or more prediction entries, each of the one or more prediction entries identified by a prediction identifier and comprising prediction information; and
in response to receipt of a given prediction identifier, performing a lookup in the prediction storage circuitry based on the given prediction identifier, and when the lookup results in a hit on a prediction entry of the one or more prediction entries:
   retrieving corresponding prediction information comprised in the prediction entry and triggering a transaction request based on the corresponding prediction information;
   performing a recursion procedure to determine whether the prediction information identifies one or more further prediction identifiers; and
   in response to the recursion procedure determining that the prediction information identifies one or more further prediction identifiers, triggering one or more further lookups in the prediction storage circuitry based on each of the one or more further prediction identifiers comprised in the prediction entry,
wherein:
each of the one or more prediction entries encodes prediction confidence information; and
the method comprises suppressing the recursion procedure when the prediction confidence information encoded in the prediction entry does not satisfy a recursive prediction condition.

According to a fifth aspect of the present techniques there is provided a non-transitory computer-readable medium storing computer-readable code for fabrication of an apparatus comprising:
prediction storage circuitry configured to store one or more prediction entries, each of the one or more prediction entries identified by a prediction identifier and comprising prediction information; and
prediction circuitry responsive to receipt of a given prediction identifier to perform a lookup in the prediction storage circuitry based on the given prediction identifier, wherein the prediction circuitry is configured, when the lookup results in a hit on a prediction entry of the one or more prediction entries:
   to retrieve corresponding prediction information comprised in the prediction entry and to trigger a transaction request based on the corresponding prediction information;
   to perform a recursion procedure to determine whether the prediction information identifies one or more further prediction identifiers; and
   in response to the recursion procedure determining that the prediction information identifies one or more further prediction identifiers, to trigger one or more further lookups in the prediction storage circuitry based on each of the one or more further prediction identifiers comprised in the prediction entry,
wherein:
each of the one or more prediction entries encodes prediction confidence information; and
the prediction circuitry is configured to suppress the recursion procedure when the prediction confidence information encoded in the prediction entry does not satisfy a recursive prediction condition.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates details of an apparatus according to some configurations of the present techniques;

FIG. 4a schematically illustrates an example of an apparatus according to some configurations of the present techniques;

FIG. 4b schematically illustrates an example of an apparatus according to some configurations of the present techniques;

FIG. 4c schematically illustrates an example of an apparatus according to some configurations of the present techniques;

FIG. 5 schematically illustrates details of an apparatus according to some configurations of the present techniques;

FIG. 6 schematically illustrates details of an apparatus according to some configurations of the present techniques;

FIG. 7 schematically illustrates storage circuitry according to some configurations of the present techniques;

FIG. 8a schematically illustrates prediction information according to some configurations of the present techniques;

FIG. 8b schematically illustrates prediction information according to some configurations of the present techniques;

FIG. 8c schematically illustrates prediction information according to some configurations of the present techniques;

FIG. 9 schematically illustrates a sequence of steps according to some configurations of the present techniques; and

FIG. 10 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising prediction storage circuitry configured to store one or more prediction entries, each of the one or more prediction entries identified by a prediction identifier and comprising prediction information. The apparatus is provided with prediction circuitry responsive to receipt of a given prediction identifier to perform a lookup in the prediction storage circuitry based on the given prediction identifier. The prediction circuitry is configured, when the lookup results in a hit on a prediction entry of the one or more prediction entries: to retrieve corresponding prediction information comprised in the prediction entry and to trigger a transaction request based on the corresponding prediction information; to perform a recursion procedure to determine whether the prediction information identifies one or more further prediction identifiers; and in response to the recursion procedure determining that the prediction information identifies one or more further prediction identifiers, to trigger one or more further lookups in the prediction storage circuitry based on each of the one or more further prediction identifiers comprised in the prediction entry. Each of the one or more prediction entries encodes prediction confidence information. Furthermore, the prediction circuitry is configured to suppress the recursion procedure when the prediction confidence information encoded in the prediction entry does not satisfy a recursive prediction condition.

The prediction storage circuitry is arranged to store entries that can be used to trigger recursive transactions. Each entry in the prediction storage comprises prediction information that is used to trigger a transaction request when a lookup results in a hit on that prediction entry. In addition, the prediction entries are capable of storing data indicative of one or more further prediction entries. For example, a sequence of entries in the prediction storage circuitry may each reference a next prediction entry in the sequence. When a lookup results in a hit on an entry in the prediction storage circuitry that identifies further entries, the prediction circuitry triggers a further lookup (or further lookups) based on those entries. Hence, for a stored sequence of entries, each identifying a next entry, a hit on one of those entries will trigger a sequence of lookups to occur with each subsequent entry in the sequence of entries being sequentially identified.

This approach of performing sequential or recursive lookups can be useful for some workloads, for example, in response to identification of a commonly used repeated sequence of lookups for data (e.g., in a linked list), or a commonly used sequence of instructions, (e.g., as a result of a repeated sequence of function calls). Whilst being able to identify these sequences of lookups, and being able to speculatively generate transactions for the sequence in response to an initial hit, may be of benefit in some workloads, there are other cases in which recursive lookups may result in high bandwidth utilisation and/or cache pollution. For example, an incorrectly identified initial lookup prediction may result in a chain of transactions that are not actually required. Because of the sequential nature of the lookups, in combination with each lookup potentially triggering plural further lookups, the penalties in terms of latency and cache pollution associated with such predictions when they are incorrectly triggered can be higher than some other prediction structures. In cases where some entries in the prediction storage circuitry each trigger multiple further lookups, this cost can become even higher.

The inventors have realised that there is a trade-off between the potential advantages of recursive prediction structures, which can result in greatly reduced latency for some workloads, and the potential cache pollution and bandwidth utilisation associated with such transactions. Whilst it could theoretically be possible to improve training algorithms used to generate entries in the prediction storage, such an approach may require a significant increase in overheads associated with such techniques. In the present techniques each entry stored in the prediction storage circuitry encodes prediction confidence information identifying a confidence in that prediction. The confidence information is therefore defined on a per entry basis with each entry being capable of storing its own confidence information. In other words, the confidence information identifies how likely it is that a recursion procedure, based on the information stored in the entry, will result in useful information being retrieved. The confidence information is therefore checked, for each entry that is retrieved subsequent to a hit in the prediction storage circuitry, to determine whether further lookups based on that entry are likely to result in useful information being retrieved. When the confidence information indicates a relatively high likelihood that the lookup will result in useful information being retrieved, then the recursion process is allowed to continue. Otherwise, the recursion process is suppressed (the prediction circuitry does not trigger a further lookup). In some configurations the prediction circuitry may be configured to suppress triggering the transaction request in addition to suppressing the recursion procedure. In other words, whilst in some configurations, the confidence information may be interpreted as a confidence in any further requests associated with the further prediction identifiers, in other configurations, the confidence is interpreted as a confidence in the transaction request associated with the current prediction identifier.

The prediction identifier may be any identifier for the prediction, e.g., a unique identifier that has been assigned to the particular prediction on allocation into the table. In some configurations the prediction identifier is based on a program counter value associated with an instruction that triggers the lookup. The prediction identifier may be all or part of the program counter value or a hash generated based on all or part of the program counter value.

The transaction request may be any type of transaction request, e.g., a load transaction or a store transaction. In some configurations the apparatus comprises storage circuitry configured to store data for processing by processing circuitry, wherein the transaction request is a request for data to be retrieved for storage in the storage circuitry. The transaction requests may be requests for data that is predicted to be required for future execution of instructions, e.g., data required for the execution of instructions and/or instructions required to be executed. The storage circuitry may be local storage circuitry, for example, the storage circuitry may comprise one or more levels of cache which may be arranged in a cache hierarchy.

In some configurations the prediction circuitry is configured to trigger the storage circuitry to associate metadata with the data, the metadata indicative that the transaction request was triggered by the prediction circuitry. The metadata may comprise a single dedicated bit stored at a predetermined location in the storage circuitry. Alternatively, the metadata may be encoded in one or more existing and otherwise utilised bits within the storage circuitry. For example, the metadata may be encoded in one or more most significant address bits, which are otherwise unused to identify addresses, and that are stored in a tagging portion of the storage circuitry. In some configurations the prediction circuitry is one of a plurality of different sets of prediction circuitry and the metadata identifies the specific prediction circuitry which results in the data being retrieved into the cache. The metadata may only be associated with the data if the data was allocated into the storage structure in response to the transaction. If the data was already present prior to the transaction, then the storage circuitry may omit the storage of the metadata. In some configurations, the metadata may be indicative of which entry in the prediction storage circuitry resulted in that data being stored in the storage circuitry.

As discussed, the transaction requests are issued in response to prediction information retrieved from the prediction storage circuitry. The transactions issued in response to the prediction are therefore speculative and any information retrieved as a result of the speculative transactions may or may not actually be required by the processing circuitry. In some configurations the storage circuitry is responsive to a demand request for the data to perform a determination of whether the metadata is associated with the data, and when the determination identifies that the metadata is associated with the data, to signal a prediction usefulness indication to the prediction circuitry. Tagging the data with metadata indicating that the data was retrieved in response to the prediction enables the storage circuitry to identify, when a demand request for the data is received whether or not the data was retrieved in response to such a speculative request. This allows the storage circuitry to feed usefulness information back to the prediction circuitry. Similarly, in some configurations, the storage circuitry is responsive to an invalidation (or eviction) request to invalidate (or evict) data having metadata associated with it, and in response to the invalidation (or eviction) request, the storage circuitry may signal an indication that the data associated with the metadata was invalidated (e.g., because other data was allocated in place of that data) prior to being requested for use by the processing circuitry.

In some configurations the storage circuitry is responsive to receipt of the demand request for the data to clear the metadata. Hence, the usefulness information transmitted to the prediction circuitry may only be sent once, i.e., the first time that a demand request for the data is received from the processing circuitry. When a subsequent demand request for the same data is received by the processing circuitry, the metadata has already been cleared and the storage circuitry will not send a further usefulness indication to the prediction circuitry. In this way, the prediction circuitry is able to build up a picture of, for each transaction resulting in data being allocated into the storage circuitry, whether the entry that resulted in the data being allocated is an accurate and timely prediction.

In some configurations the prediction circuitry is responsive to receipt of an indication that the prediction comprised in one of the one or more prediction entries resulted in retrieval of data subsequently forwarded to processing circuitry, to update the prediction confidence information encoded in that one of the of the one or more prediction entries. In response to receipt of the indication, the prediction circuitry may increase the prediction confidence (e.g., by one of incrementing or decrementing a value). In some configurations the prediction circuitry is responsive to receipt of an indication that the data associated with the metadata was invalidated without being requested for use by the processing circuitry (e.g., the data was invalidated or evicted before being requested by the processing circuitry or in absence of a request by the processing circuitry), to update the prediction confidence information to indicate a decrease in the prediction confidence (e.g., by the other of incrementing or decrementing the value).

The prediction confidence information may be encoded in each entry in a variety of ways. In some configurations for each prediction entry of the one or more prediction entries, the prediction confidence information comprises one or more counters indicative of utilisation of that prediction entry. The one or more counters may be one of incremented or decremented in response to the receipt of the indication that the data resulting from that entry was utilised by the processing circuitry. Alternatively, or in addition, the one or more counters may be the other of incremented or decremented in response to receipt of the indication that the data resulting from that entry was invalidated (or otherwise evicted from the storage circuitry) before it was utilised by the processing circuitry. A value of that one of the one or more counters may therefore be used to determine whether a particular prediction generally results in useful data being retrieved into the storage circuitry.

The counters may be variously defined and may comprise a single counter or a plurality of counters for each entry. In some configurations the one or more counters comprises a prediction hit counter indicative of a number of successful transaction requests resulting in retrieval of data subsequently forwarded to processing circuitry. In some configurations, the prediction hit counter may be initialised to zero and is incremented as the number of successful transaction requests increases. In such configurations, the prediction hit counter need not have a mechanism by which it decreases. Rather, the prediction circuitry may rely on that prediction entry being overwritten by a new prediction entry, for example, as the processing circuitry moves on to operate in a different region of code. Alternatively, and as discussed above, the prediction circuitry may be responsive to an indication that data allocated as a result of that entry was invalidated (or otherwise evicted from the storage circuitry), to decrement the prediction hit counter.

In some configurations the prediction hit counter is a saturating counter. The prediction hit counter may be provided using a relatively small number of bits, for example, the prediction hit counter may be a 2-bit saturating counter having a total of 4 possible discrete confidence levels. In general, the prediction hit counter may be provided as an N-bit counter, where N is any integer. In general, the greater N is, the finer grained the confidence levels can be, however, as N increases, the overhead of storing such a counter also increases.

In addition, or as an alternative to the prediction hit counter, in some configurations the one or more counters comprises a prediction counter identifying a number of transaction requests issued in response to hits on that prediction entry. The prediction counter may be set to zero when a new entry is provided in the prediction storage circuitry. The prediction counter may be a saturating counter. The provision of a prediction counter enables the prediction circuitry to identify how many times that prediction has been used (e.g., a hit on a prediction entry in the prediction storage circuitry resulting in a transaction request being issued). In some configurations a frequently used prediction counter may have a different recursive prediction condition than an infrequently used prediction. In some configurations a threshold for the prediction confidence may be higher for a frequently used prediction than for an infrequently used prediction.

Whilst the prediction counter may be an absolute counter (or a saturating absolute counter) indicating the absolute number of times a transaction request is issued in response to a hit on an entry, in some configurations the prediction counter is a relative prediction counter, and the one or more counters comprises a relative success counter indicative of a relative number of successful transaction requests resulting in retrieval of data subsequently forwarded to processing circuitry; and the prediction circuitry is responsive to saturation of the relative prediction counter to reduce both the relative success counter and the relative prediction counter by a same scaling factor. The provision of multiple counters for each entry requires additional storage space in the pattern storage circuitry. Rather than providing a relatively large multi-bit counter for each of the relative prediction counter and the relative success counter, a smaller counter can be provided. When one of the relative prediction counter and the relative success counter saturates, both the relative prediction counter and the relative success counter are reduced by a same scaling factor such that a ratio of the relative success counter to the relative prediction counter remains the same. In some configurations, the same scaling factor is a power of two and the reduction by the scaling factor comprises right shifting each of the relative prediction counter and the relative success counter by a same number of places. In some configurations, the recursive prediction condition is met when a ratio of the relative success counter to the relative prediction counter meets a threshold condition. Because the recursive prediction condition is based on the relative sizes of each of the relative success counter and the relative prediction counter, both these counters can be implemented using fewer bits resulting in a smaller circuit arca for the prediction storage circuitry.

In some configurations the prediction circuitry is configured to maintain recursion depth information associated with the lookup and to increment the recursion depth information when triggering the one or more further lookups, and the recursive prediction condition is dependent on the recursion depth information. The inventors have realised that, due to the tree like structure of the requests, e.g., that each lookup resulting in a hit may trigger plural further lookups, the more levels of recursion that are performed, the greater the potential performance penalty. As an illustrative example, if (e.g., due to a particular pattern of use by a process running on processing circuitry associated with the prediction storage) each entry in the prediction storage circuitry triggered two further lookups in the prediction storage circuitry, then by the Nth level of recursion there would be 2^{N} lookups. As N increases these lookups could quickly result in high bandwidth usage and cache pollution. Of course, if these lookups are expected to result in transactions that are both timely and accurate, it would be desirable to allow these transactions to continue. However, the potential penalty for allowing lookups that turn out to be inaccurate or not timely, will increase with the recursion level N (the recursion depth). By tracking the recursion depth of the lookup and basing the recursion condition on that depth information, the prediction circuitry is able to balance the potential risk of allowing the recursion procedure to continue.

In some configurations the prediction circuitry is configured to: identify a confidence threshold based on the recursion depth information; and to determine that the recursive prediction condition is satisfied when the prediction confidence information is greater than or equal to the confidence threshold. The confidence threshold may be different for each possible value of the recursion depth or may be the same for at least some of the values of the recursion depth. The confidence threshold may be one of a low depth confidence threshold utilised when the recursion depth is lower than a predefined depth and a high depth confidence threshold utilised when the recursion depth is not lower than the predefined depth.

The confidence threshold can be determined in a variety of ways, for example, the confidence threshold may be determined from a mathematical function taking the depth information as an input. In some configurations the mathematical function may be a monotonically increasing function. In some configurations the confidence threshold is identified from an integer multiple of the depth information. In other words, the confidence threshold may be linearly related to the depth information. In alternative configurations the confidence threshold may be non-linearly related to the depth information. In some configurations, the confidence threshold is equal to 2^{M} where M is the depth information. In some configurations the confidence threshold may be a saturating threshold which is equal to a maximum confidence threshold once the depth information exceeds a predefined value. In some configurations the confidence threshold is identified from a lookup table indexed using the depth information. The lookup table may be hardwired or may be configurable by a process having a sufficiently high privilege level.

The prediction circuitry may be any kind of prediction circuitry. In some configurations the apparatus comprises prefetch generation circuitry configured to generate, as the transaction request, a prefetch request to prefetch data into local storage circuitry in advance of a demand request for the data by processing circuitry. The prediction storage circuitry may therefore comprise prefetch prediction storage circuitry configured to store address information associated with data items to be prefetched using the prefetch requests into a data cache. The prediction storage circuitry may store entries identified from training circuitry, for example, prefetch training circuitry associated with the prefetch generation circuitry.

In addition, or as an alternative, the apparatus comprises branch prediction circuitry configured to issue the transaction request to an instruction prefetching queue to trigger a block of one or more instructions to be fetched into local instruction storage circuitry in anticipation of a flow of instructions requiring the block of one or more instructions. The prediction storage circuitry may therefore comprise branch prediction storage circuitry configured to store address information associated with blocks of instructions to be fetched into an instruction cache. The prediction storage circuitry may store entries identified from branch prediction training circuitry associated with the branch prediction circuitry.

For configurations in which the prediction storage circuitry comprises information associated with both prefetch generation circuitry and branch prediction circuitry, the prediction storage circuitry may comprise separate storage regions, one associated with the branch prediction circuitry and one associated with the prefetch circuitry. Alternatively, a single storage region may be provided with entries tagged to indicate whether they relate to a prefetch entry or a branch prediction entry. Each entry of the prediction storage circuitry may comprise additional metadata according to the prediction structure (branch prediction circuitry or prefetch prediction circuitry) with which that entry is associated.

Some configurations of the present techniques will now be described with reference to the accompanying figures.

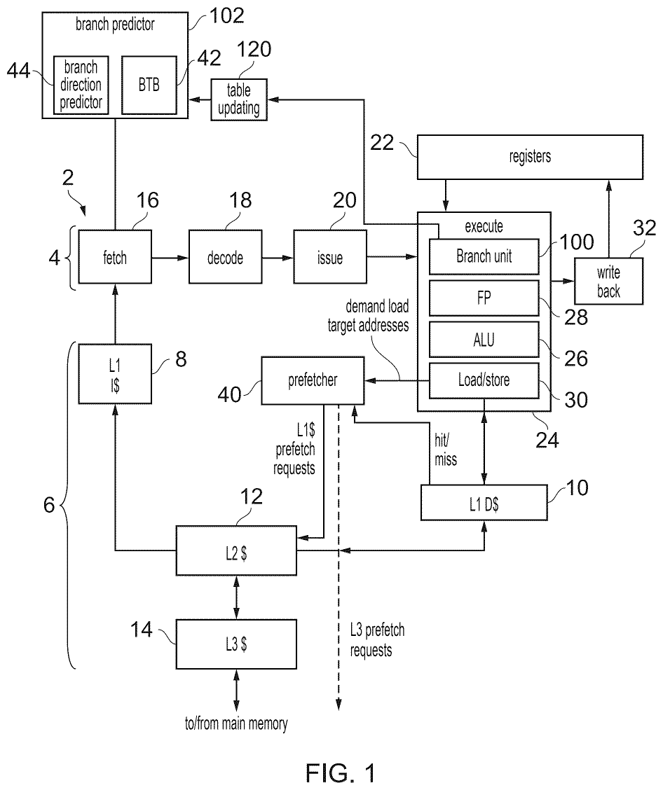

FIG. 1 illustrates an example of a data processing apparatus 2. The apparatus has a processing pipeline 4 for processing program instructions fetched from a memory system 6. The memory system in this example includes a level 1 instruction cache 8, a level 1 data cache 10, a level 2 cache 12 shared between instructions and data, a level 3 cache 14, and main memory which is not illustrated in FIG. 1 but may be accessed in response to requests issued by the processing pipeline 4. It will be appreciated that other examples could have a different arrangement of caches with different numbers of cache levels or with a different hierarchy regarding instruction caching and data caching (e.g. different numbers of levels of cache could be provided for the instruction caches compared to data caches).

The processing pipeline 4 includes a fetch stage 16 for fetching program instructions from the instruction cache 8 or other parts of the memory system 6. The fetched instructions are decoded by a decode stage 18 to identify the types of instructions represented and generate control signals for controlling downstream stages of the pipeline 4 to process the instructions according to the identified instruction types. The decode stage passes the decoded instructions to an issue stage 20 which checks whether any operands required for the instructions are available in registers 22 and issues an instruction for execution when its operands are available (or when it is detected that the operands will be available by the time they reach the execute stage 24). The execute stage 24 includes a number of functional units 26, 28, 30, 100 for performing the processing operations associated with respective types of instructions. For example, in FIG. 1 the execute stage 24 is shown as including an arithmetic/logic unit (ALU) 26 for performing arithmetic operations such as add or multiply and logical operations such as AND, OR, NOT, etc. Also the execute unit includes a floating point unit 28 for performing operations involving operands or results represented as a floating-point number. A branch unit 100 is provided for evaluating the outcome of branch operations and adjusting the program counter which represents the current point of execution accordingly. Also the functional units include a load/store unit 30 for executing load instructions to load data from the memory system 6 to the registers 22 or store instructions to store data from the registers 22 to the memory system 6. Load requests issued by the load/store unit 30 in response to executed load instructions may be referred to as demand load requests. Store requests issued by the load/store unit 30 in response to executed store instructions may be referred to as demand store requests. The demand load requests and demand store requests may be collectively referred to as demand memory access requests. It will be appreciated that the functional units shown in FIG. 1 are just one example, and other examples could have additional types of functional units, or could have multiple functional units of the same type, or may not include all of the types shown in FIG. 1 (e.g. some processors may not have support for floating-point processing). The results of the executed instructions are written back to the registers 22 by a write back stage 32 of the processing pipeline 4.

It will be appreciated that the pipeline architecture shown in FIG. 1 is just one example and other examples could have additional pipeline stages or a different arrangement of pipeline stages. For example, in an out-of-order processor a register rename stage may be provided for mapping architectural registers specified by program instructions to physical registers identifying the registers 22 provided in hardware. Also, it will be appreciated that FIG. 1 does not show all of the components of the data processing apparatus and that other components could also be provided. For example, a memory management unit could be provided for controlling address translation between virtual addresses specified by the program instructions and physical addresses used by the memory system.

As shown in FIG. 1, the apparatus 2 has a prefetcher 40 for analyzing patterns of demand target addresses specified by demand memory access requests issued by the load/store unit 30, and detecting address access patterns which can subsequently be used to predict addresses of future memory accesses. For example, the address access patterns may involve stride sequences of addresses where there are a number of addresses separated at regular intervals of a constant stride value, or where there are frequent occurrences of a given offset between addresses of one memory access and a later memory access. It is also possible to detect other kinds of address access patterns (e.g. a pattern where subsequent accesses target addresses at certain offsets from a start address). The prefetcher 40 maintains prefetch state information representing the observed address access patterns, and uses the prefetch state information to generate prefetch load requests which are issued to the memory system 6 to request that data is brought into a given level of cache. For example, when a trigger event for a given access pattern is detected (e.g. the trigger event could be program flow reaching a certain program counter address, or a load access to a particular trigger address being detected), the prefetcher 40 may begin issuing prefetch load requests for addresses determined according to that pattern. The prefetch load requests are not directly triggered by a particular instruction executed by the pipeline 4, but are issued speculatively with the aim of ensuring that when a subsequent load/store instruction reaches the execute stage 24, the data it requires may already be present within one of the caches, to speed up the processing of that load/store instruction and therefore reduce the likelihood that the pipeline has to be stalled.

The prefetcher 40 may be able to perform prefetching into a single cache or into multiple caches. For example, FIG. 1 shows an example of the prefetcher 40 issuing level 1 cache prefetch requests which are sent to the level 2 cache 12 or downstream memory and request that data from prefetch target addresses is brought into the level 1 data cache 10. Also the prefetcher 40 in this example could also issue level 2 prefetch requests to the level 3 cache 14 or main memory requesting that data from prefetch target addresses is loaded into the level 2 cache 14, and/or level 3 prefetch requests to the main memory requesting that data from prefetch target addresses is loaded into the level 3 cache 14. The level 2 or level 3 prefetch requests may look a longer distance into the future than the level 1 prefetch requests to account for the greater latency expected in obtaining data from main memory into the level 2 or 3 cache 12, 14 compared to obtaining data from a level 2 cache into the level 1 cache 10. In systems using prefetching into multiple levels of cache, prefetches at level 2 or 3 can increase the likelihood that data requested by a level 1 prefetch request or demand access request is already in the level 2 or 3 cache. However, it will be appreciated that the particular caches loaded based on the prefetch requests may vary depending on the particular circuit implementation.

As shown in FIG. 1, as well as the demand target addresses issued by the load/store unit 30, the training of the prefetcher 40 may also be based on an indication of whether the corresponding demand memory access requests hit or miss in the level 1 data cache 10. The hits/miss indication can be used for filtering the demand target addresses from training. This recognises that it may not be useful to expend prefetch resource on addresses for which the demand target addresses would anyway hit in the cache. Performance improvement can be greater in focusing prefetcher training on those addresses which, in the absence of prefetching, would have encountered cache misses for the demand access requests.

While FIG. 1 shows a single instance of a prefetcher 40, it will be appreciated that some implementations may comprise more than one prefetcher, e.g. prefetchers trained to detect different kinds of memory access patterns and/or prefetchers trained on memory access requests processed by different levels of caches.

As shown in FIG. 1, the apparatus 2 includes a branch predictor 102 for predicting outcomes of branch instructions. The branch predictor is looked up based on addresses of instructions provided by the fetch stage 6 and provides a prediction on whether those instructions are predicted to include branch instructions, and for any predicted branch instructions, a prediction of their branch properties such as a branch type, branch target address and branch direction (predicted branch outcome, indicating whether the branch is predicted to be taken or not taken). The branch predictor 102 includes a branch target buffer (BTB) 42 for predicting properties of the branches other than branch direction, and a branch direction predictor (BDP) 44 for predicting the not taken/taken outcome (branch direction). It will be appreciated that the branch predictor could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios.

As shown in FIG. 1, the apparatus 2 may have table updating circuitry 120 which receives signals from the branch unit 100 indicating the actual branch outcome of instructions, such as indications of whether a taken branch was detected in a given block of instructions, and if so the detected branch type, target address or other properties. If a branch was detected to be not taken, then this is also provided to the table updating circuitry 120. The table updating circuitry 120 then updates state within the BTB 42, the branch direction predictor 44 and other branch prediction structures to take account of the actual results seen for an executed block of instructions, so that it is more likely that on encountering the same block of instructions again then a correct prediction can be made.

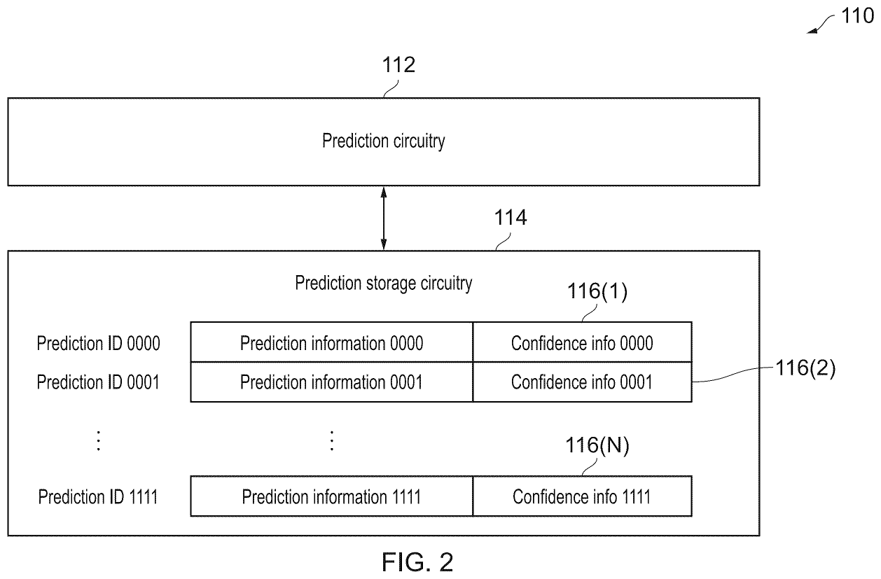

FIG. 2 schematically illustrates an apparatus 110 according to some configurations of the present techniques. The apparatus 110 comprises prediction circuitry 112 and prediction storage circuitry 114. The prediction storage circuitry 114 is arranged to store a plurality of prediction entries 116 including a first prediction entry 116(1), a second prediction entry 116(2), . . . , and a N^{th} prediction entry 116(N). Each prediction entry 116 comprises prediction information and prediction confidence information. The prediction circuitry 112 is responsive to receipt of a given prediction identifier to perform a lookup in the prediction storage circuitry 114 to determine if the received prediction identifier corresponds to an entry stored in the prediction storage circuitry 114. The lookup may comprise generating an index from the prediction identifier and performing the lookup based on the index. The prediction circuitry 112 is responsive to the lookup in the prediction storage circuitry 114 resulting in a hit to retrieve the prediction information comprised in the prediction entry 116 and to trigger a transaction request based on that prediction information. The prediction circuitry 112 also determines whether the confidence information stored in the prediction entry 116 satisfies a recursive prediction condition. If the prediction information stored in the prediction entry 116 satisfies the recursive prediction condition, then the prediction circuitry 112 performs a recursion procedure to determine if the prediction information in the prediction entry 116 identifies any further prediction identifiers. If further prediction identifiers are identified in the prediction information of the prediction entry 116, then the prediction circuitry 112 triggers a further lookup for each identified prediction identifier. Alternatively, if the prediction confidence information does not satisfy the recursive prediction condition, then the prediction circuitry 112 does not perform the recursion procedure.

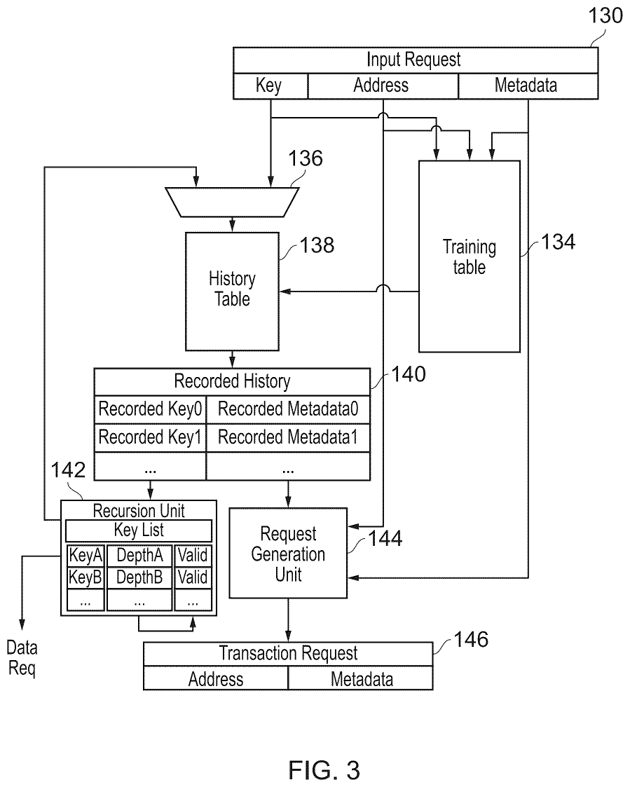

FIG. 3 schematically illustrates details of recursive prediction. An input request 130 is received comprising a key (an example of a prediction identifier), an address, and metadata. The address and metadata of the received input request 130 is provided to a request generation unit 144 which is configured to generate a transaction request 146 in response to the received address and metadata. The input request 130 including the key, the address and the metadata is passed to the training table 134 which monitors input requests to detect sequences of requests that are observed to occur. The training table 134 may maintain one or more training structures to monitor the input requests and relationships between those requests using techniques known to the person of ordinary skill in the art. When a recursive request is found, i.e., when it is determined that a particular input request, for example, the input request 130, identifies an address and that the input request 130 is typically followed by another request specifying a further address (or other requests each specifying a respective further address), the training table outputs prediction information to be stored in the history table 138 (an example of prediction storage circuitry). The history table 138 stores information indicative of one or more prediction entries each identified by a prediction identifier and comprising prediction information.

In addition, the input request 130 is passed, via selection circuitry 136 (e.g., de-multiplexing circuitry) to the pattern history table 138 to trigger a lookup based on the key provided as part of the input request. The history table 138 is responsive to receipt of the key and performs the lookup. The history table 138 comprises a recorded history 140 the recorded history comprises recorded keys and metadata (prediction information). A hit in the history table causes the prediction information stored in that entry in the history table to be retrieved. The retrieved prediction information is passed to the request generation unit 144 to generate a transaction request based on the retrieved prediction information. Furthermore, the retrieved prediction information is passed to the recursion unit 142 (for example, comprised in the prediction circuitry). The recursion unit 142 identifies, from the prediction information, whether the prediction information identifies one or more further keys (further prediction identifiers). The recursion unit tracks the recursion depth of the prediction information and whether the entry is valid. In response to identification of a further valid key, the recursion unit 142 triggers a further lookup in the history table 138 by outputting the key to the selection circuitry 136 which, in turn, is passed to the history table 138 to trigger a further lookup.

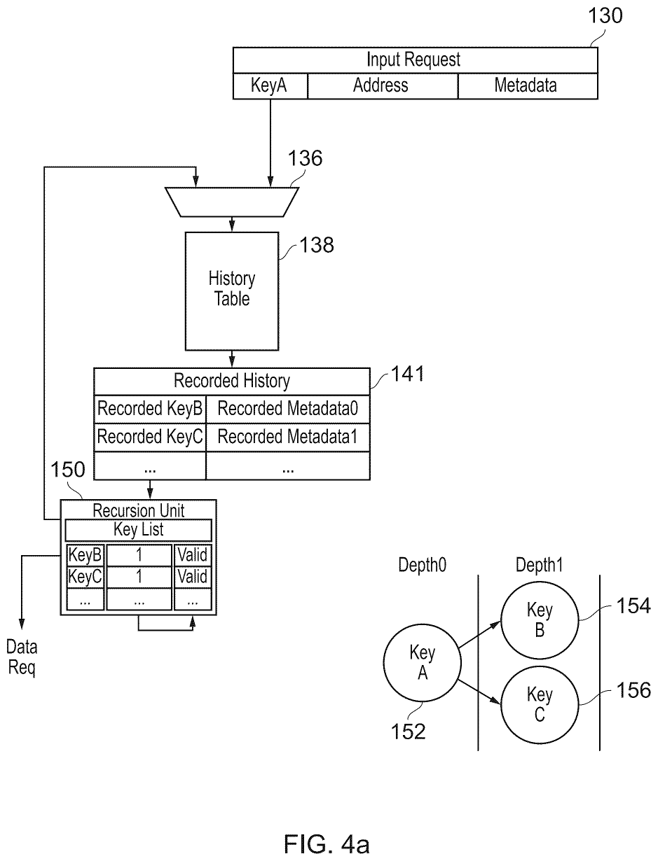

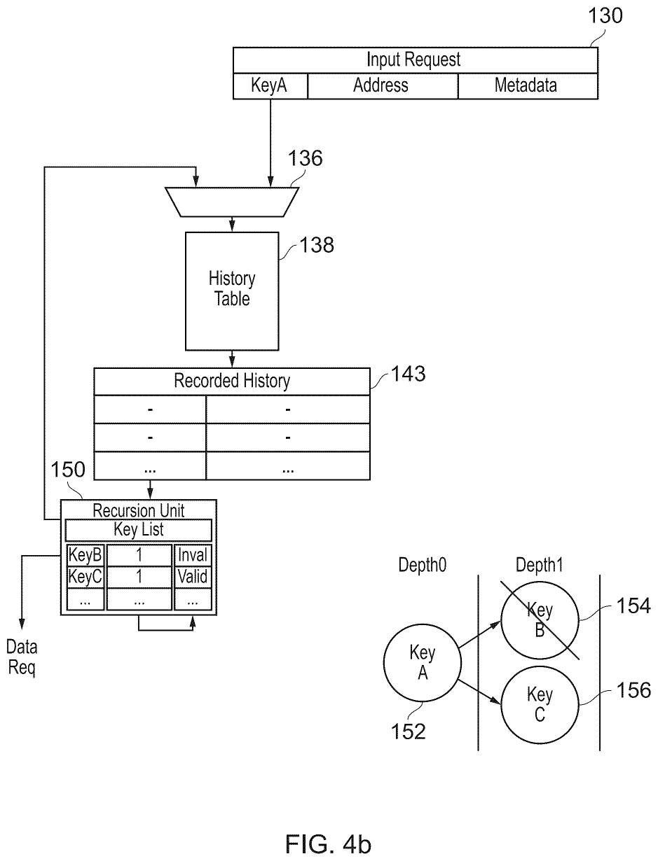

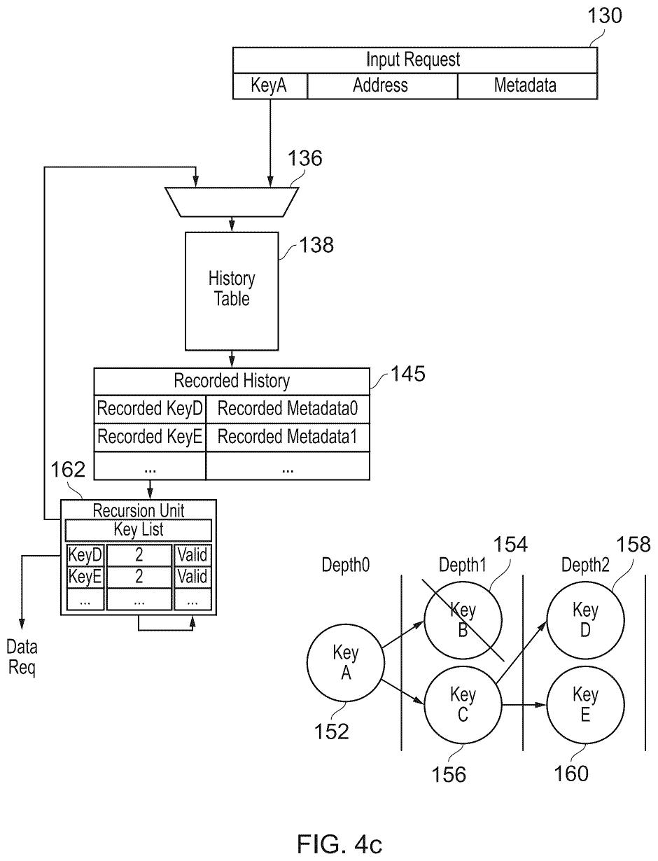

FIGS. 4a to 4c provide an illustrative example of a recursion process that may be carried out in response to receipt of an input request 130. The recursion process begins in FIG. 4a in which an input request 130 is received. The input request 130 comprises a key which is passed, via selection circuitry 136 to the history table 138. A lookup in the history table 138 results in a hit at depth zero based on key A 152 identifying recorded history 141. The recorded history 141 retrieved from the history table 138 for key A 152 identifies two further prediction identifiers: key B 154 and key C 156. Key B 154 and key C 156 are stored in the recursion unit 150 with an indicated depth of 1 for each of key B 154 and key C 156. In FIG. 4b a lookup based on key B 154 is performed in the history table 138. The lookup based on key B 154 results in a miss in the history table, i.e., there is no recorded history 143 for key B 154. Hence, no further recursion can be performed based on key B 154 and no further transactions are issued based on key B154. In FIG. 4c a lookup based on key C 156 is performed in the history table 138. The lookup based on key C 156 results in a hit in the history table. The recorded history 145 identified for key C 156 identifies two further prediction identifiers: key D 158 and key E 160. Key D 158 and key E 160 are stored in the recursion unit 150 with an indicated depth of 2 for each of key D 158 and key E 160. Subsequently lookups are performed based on each of key D158 and key E160. For each lookup that hits in the history table 138, a transaction request is issued based on prediction information identified in the hit.

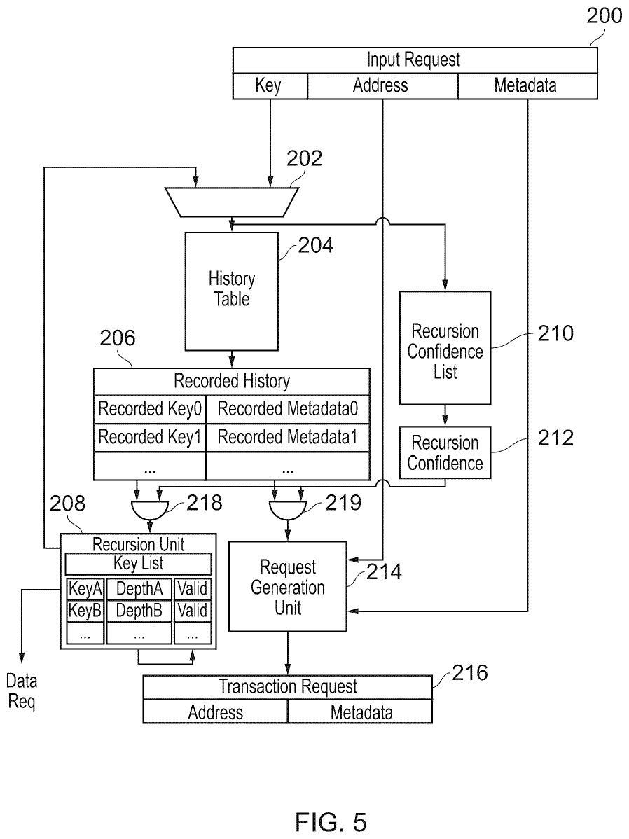

FIG. 5 schematically illustrates an apparatus according to some configurations of the present techniques. The apparatus is provided with a recursion confidence list 210 (stored, for example, in the prediction storage circuitry). When a key is provided to the history table 204, for example, based on the input request 200 (as described in relation to FIG. 3) passed through the selection circuitry 202, or based on a lookup provided by the recursion unit 208 through the selection circuitry 202, the key is also provided to the recursion confidence list 210. A lookup is performed in the recursion confidence list 210 to retrieve recursion confidence information 212. Where it is determined, for example, by the prediction circuitry, that the recursion confidence 212 for that key satisfies a recursive prediction condition, then a signal is issued to AND circuitry 218 and to AND circuitry 219 to enable any recorded history 206 identified based on the lookup in the history table 204 to be passed to the request generation unit 214 and to the recursion unit 208. Hence, when the recursion confidence information 212 associated with a particular key does not satisfy the recursive prediction condition, then the recorded history 206 is not passed to the request generation unit 214 and is not passed to the recursion unit 208. Hence, the recursion process for that key stops in the same manner as if the key had missed in the prediction history table. In this way, the recursion procedure is truncated when the confidence information associated with a particular entry does not meet the recursive prediction condition.

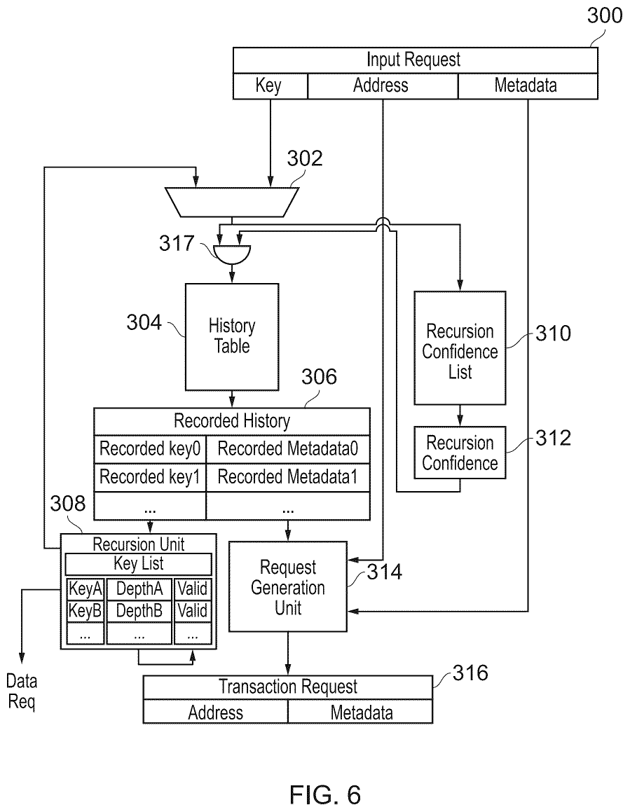

FIG. 6 schematically illustrates an alternative arrangement that may be provided according to some configurations of the present techniques. The apparatus is provided with a recursion confidence list 310 (stored, for example, in the prediction storage circuitry). When a key is provided to the history table 304, for example, based on the input request 300 (as described in relation to FIG. 3) passed through the selection circuitry 302, or based on a lookup provided by the recursion unit 308 through the selection circuitry 302, the key is also provided to the recursion confidence list 310. A lookup is performed in the recursion confidence list 310 to retrieve recursion confidence information 312. Where it is determined, for example, by the prediction circuitry, that the recursion confidence 312 for that key satisfies a recursive prediction condition, then a signal is issued to AND circuitry 317 to enable the key with which that recursion confidence information 312 is associated to be passed be passed to the history table 304 to trigger a lookup. Hence, when the recursion confidence information 312 associated with a particular key does not satisfy the recursive prediction condition, then the recorded history 306 is not passed to the history table 304, thereby preventing any recorded history 306 associated with that key from being retrieved and passed to the request generation unit 314 or to the recursion unit 308. Hence, the recursion process for that key stops in the same manner prior to the lookup in the prediction history table.

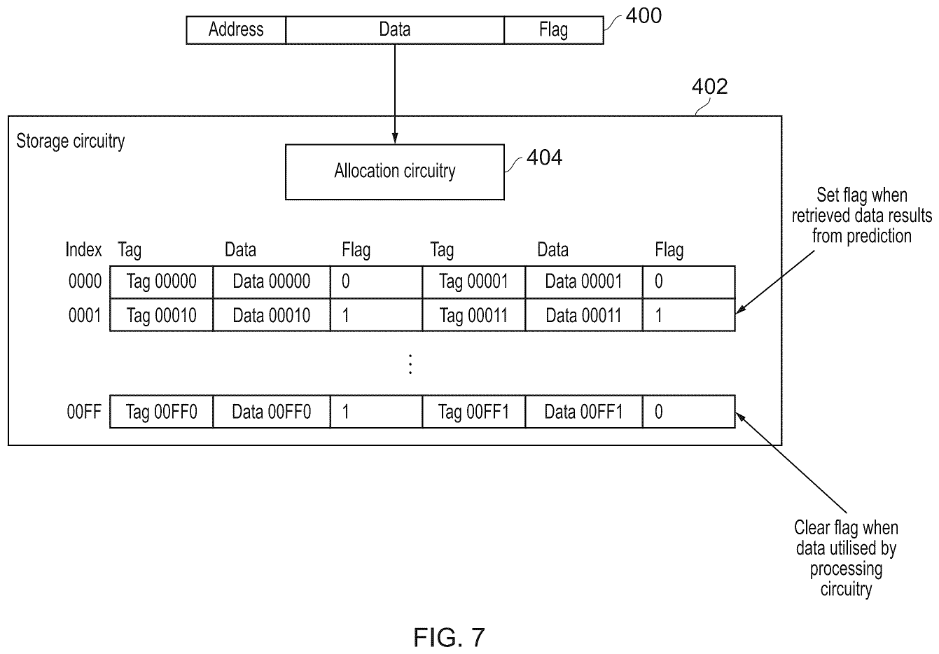

FIG. 7 schematically illustrates storage circuitry 402 according to some configurations of the present techniques. The storage circuitry comprises allocation circuitry 404 to allocate received data into the storage circuitry 402. The storage circuitry is arranged as a set associative cache having associativity of two. The storage circuitry 402 is configured to store received data in association with a flag that identifies whether or not that data was retrieved as a result of a recursive prediction.

The allocation circuitry 404 receives a transaction 400 to be allocated into the storage circuitry 402. The transaction comprises an address from which the data was retrieved, the data itself, and flag indicating whether or not that transaction originated from the prediction circuitry. The allocation circuitry 404 allocates the data retrieved by the transaction according to an allocation policy, for example, the allocation circuitry 404 may identify a set of data having an index generated from the address received in the transaction and deallocate a least recently used way from that set in order to allocated the received data. On allocation into the storage circuitry 402, the allocation circuitry 404 sets the flag in the corresponding entry of the storage circuitry to indicate that the data was retrieved in response to a transaction issued by the prediction circuitry.

The storage circuitry is responsive to demand requests for data to be forwarded to the processing circuitry for execution to retrieve that data (for example, by performing a lookup in the storage circuitry based on an address of the data) and, when the data is present in the storage circuitry 402, to forward that data for execution. In addition to forwarding the data to the processing circuitry for execution, the storage circuitry 402 indicates to the prediction circuitry that the data retrieved based on a transaction issued by the prediction circuitry has been forwarded to processing circuitry for execution and clears the flag to indicate that the data has been used by the processing circuitry.

Indicating to the prediction circuitry may comprise indicating the address of the data, or other identifying information to the prediction circuitry, e.g., a prediction identifier. The prediction circuitry is responsive to receipt of this indication to update the confidence information associated with that prediction.

It will be readily apparent to the skilled person that the storage circuitry need not be arranged as a set associative cache having associativity of two and, instead, could be arranged as a fully associative cache, an indexed cache, or a set associative cache having associativity other than two.

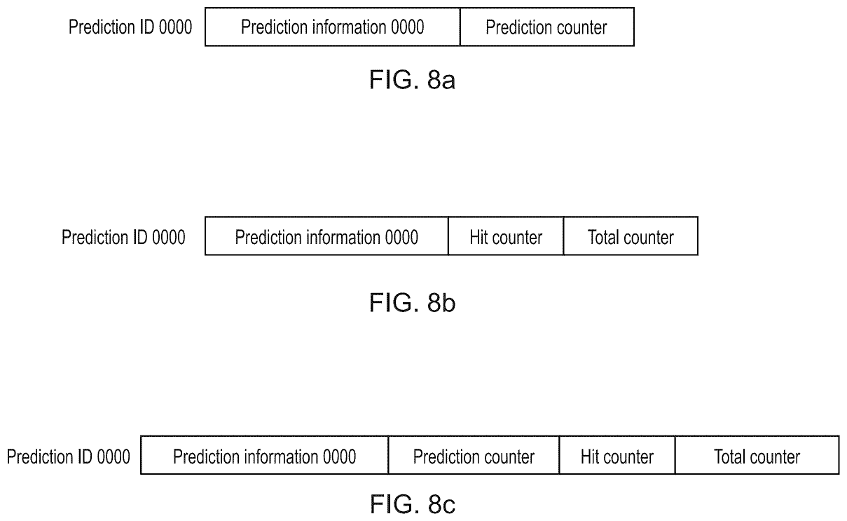

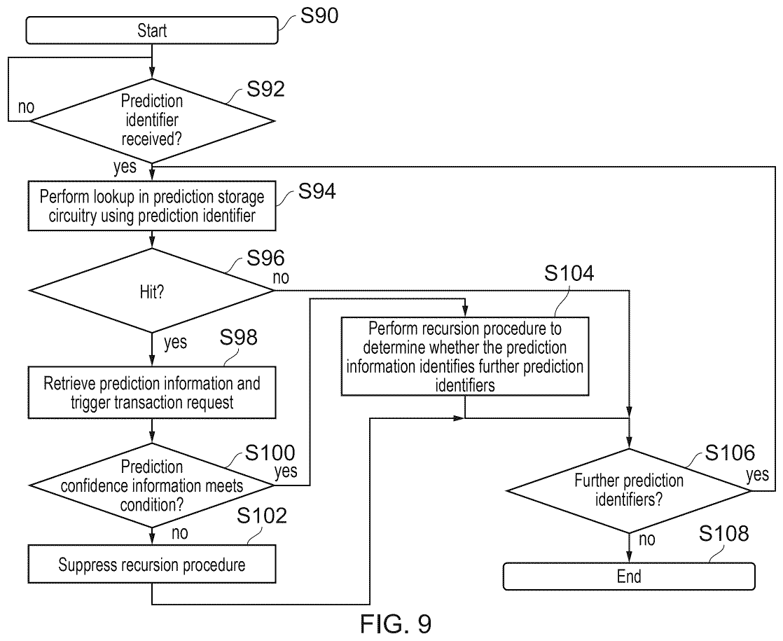

FIGS. 8a to 8c schematically illustrate the use of counters to track the confidence information associated with each prediction entry. FIG. 8a schematically illustrates a prediction entry stored in prediction storage circuitry that is identified by a prediction identifier. The prediction entry comprises prediction information as described above and a prediction counter. The prediction counter identifies a total number of times that data retrieved as a result of a transaction issued by the prediction circuitry has been forwarded to processing circuitry for execution. On allocation of the prediction entry, the prediction counter is set to zero and is incremented in response to an indication that data retrieved as a result of a transaction issued by the prediction circuitry has been forwarded to processing circuitry for execution. The prediction counter is implemented as a saturating counter. It is noted that, in this configuration, the prediction counter may decrease as a result of an indication that data retrieved as a result of a transaction issued by the prediction circuitry has been evicted from the storage circuitry without being forwarded to processing circuitry for execution. Alternatively, the prediction counter may only increase under the assumption that, when processing moves on and the prediction is no longer useful, it will eventually be replaced by a new prediction according to an allocation policy associated with the prediction storage circuitry. The prediction counter may be used as the prediction confidence information.

FIG. 8b schematically illustrates an alternative configuration in which two counters are provided, a hit counter and a total counter. The hit counter is incremented and/or decremented as described in relation to the prediction counter of FIG. 8a. In addition, a total counter is provided that indicates a total number of times that the prediction has resulted in a transaction being issued. The prediction confidence information may be derived based on a ratio of the hit counter and the total counter. The hit counter and the total counter may be provided as relative saturating counters which are each initialised to zero. When one of the total counter and the hit counter saturates, each of the total counter and the hit counter are divided by two (e.g., their bits are right shifted with a zero value shifted in from the left). As a result, the absolute value of the hit counter and the total counter may not directly represent the confidence of the prediction information, however, the ratio of the two may be used as the confidence information.

FIG. 8c schematically illustrates a further configuration in which both an absolute prediction counter, for example, as described in relation to FIG. 8a, and the relative hit counter and the relative total counter, for example as described in relation to FIG. 8b, are provided. In this configuration, all three counters may be used together to determine the confidence information according to one or more rules or schemes. For example, the recursive prediction condition may be assumed to be satisfied when the ratio of the hit counter and the total counter meets a first condition, and when the prediction counter meets a second condition.

FIG. 9 schematically illustrates a sequence of steps according to some configurations of the present techniques. Flow begins at step S90. Flow then proceeds to step S92 where it is determined if a prediction identifier has been received. If, at step S92, it is determined that no prediction identifiers have been received, then flow remains at step S92. If, at step S92, it is determined that a prediction identifier has been received, then flow proceeds to step S94. At step S94, a lookup is performed in prediction storage using the prediction identifier. At step S96, it is determined if the lookup resulted in a hit. If, at step S96, it is determined that there is not a hit in the prediction storage circuitry, then flow proceeds to step S106. If, at step S96, it is determined that the lookup did result in a hit, then flow proceeds to step S98 where prediction information is retrieved and a request is triggered based on the prediction information. Flow then proceeds to step S100 where it is determined if the prediction confidence meets a condition (e.g., a recursive prediction condition). If, at step S100, it is determined that the prediction confidence information does not meet the prediction confidence condition, then flow proceeds to step S102 where the recursion procedure is suppressed before flow proceeds to step S106. If, at step S100, it is determined that the prediction confidence information meets the condition, then flow proceeds to step S104. At step S104 a recursion procedure is performed to determine whether the prediction information identifies any further prediction identifiers before flow proceeds to step S106. At step S106, it is determined whether there are any further prediction identifiers (e.g., prediction identifiers identified as part of prediction information). If, at step S106, it is determined that there are further prediction identifiers, then flow returns to step S94. If, at step S106, it is determined that there are not any further prediction identifiers then flow proceeds to step S108 where the flow ends.

It will be readily apparent to the skilled person that, in some configurations, the determination at step S100 could be performed before step S98, with step S98 only being performed if the confidence information meets the condition (i.e., a “yes” decision at step S100).

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

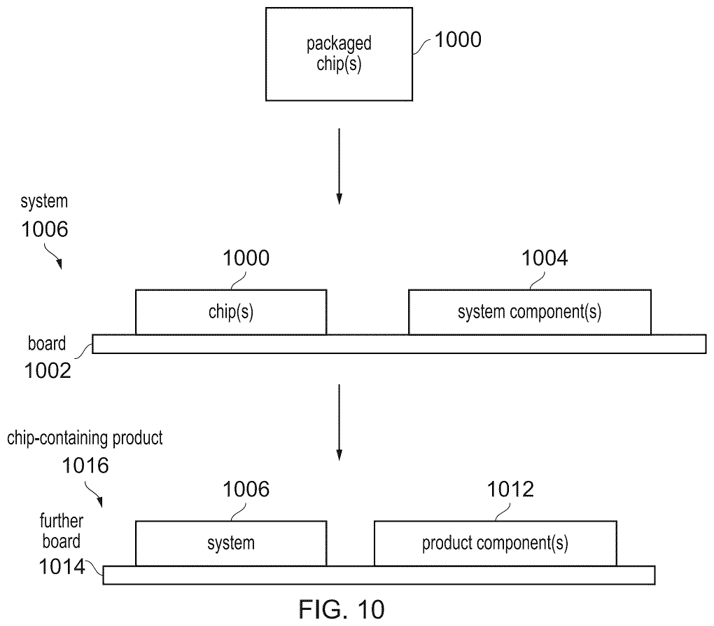

As shown in FIG. 10, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising prediction storage circuitry to store prediction entries. Each of the prediction entries is identified by a prediction identifier and comprises prediction information. The apparatus is provided with prediction circuitry responsive to receipt of a given prediction identifier to perform a lookup in the prediction storage circuitry. The prediction circuitry is configured, when the lookup results in a hit to retrieve corresponding prediction information and to trigger a transaction request. In further response to the hit, the prediction circuitry is also configured to perform a recursion procedure to determine whether the prediction information identifies further prediction identifiers, and if so, to trigger further lookups based on each of the further prediction identifiers. The prediction entries encode prediction confidence information, and the prediction circuitry is configured to suppress the recursion procedure when the prediction confidence information does not satisfy a recursive prediction condition.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
prediction storage circuitry configured to store one or more prediction entries, each of the one or more prediction entries identified by a prediction identifier and comprising prediction information; and
prediction circuitry responsive to receipt of a given prediction identifier to perform a lookup in the prediction storage circuitry based on the given prediction identifier, wherein the prediction circuitry is configured, when the lookup results in a hit on a prediction entry of the one or more prediction entries:
   to retrieve corresponding prediction information comprised in the prediction entry and to trigger a transaction request based on the corresponding prediction information;
   to perform a recursion procedure to determine whether the prediction information identifies one or more further prediction identifiers; and
   in response to the recursion procedure determining that the prediction information identifies one or more further prediction identifiers, to trigger one or more further lookups in the prediction storage circuitry based on each of the one or more further prediction identifiers comprised in the prediction entry,
wherein:
each of the one or more prediction entries encodes prediction confidence information; and
the prediction circuitry is configured to suppress the recursion procedure when the prediction confidence information encoded in the prediction entry does not satisfy a recursive prediction condition.

Clause 2. The apparatus of clause 1, comprising storage circuitry configured to store data for processing by processing circuitry, wherein the transaction request is a request for data to be retrieved for storage in the storage circuitry.

Clause 3. The apparatus of clause 2, wherein the prediction circuitry is configured to trigger the storage circuitry to associate metadata with the data, the metadata indicative that the transaction request was triggered by the prediction circuitry.

Clause 4. The apparatus of clause 3, wherein the storage circuitry is responsive to a demand request for the data to perform a determination of whether the metadata is associated with the data, and when the determination identifies that the metadata is associated with the data, to signal a prediction usefulness indication to the prediction circuitry.

Clause 5. The apparatus of clause 4, wherein the storage circuitry is responsive to receipt of the demand request for the data to clear the metadata.

Clause 6. The apparatus of any preceding clause, wherein the prediction circuitry is responsive to receipt of an indication that the prediction comprised in one of the one or more prediction entries resulted in retrieval of data subsequently forwarded to processing circuitry, to update the prediction confidence information encoded in that one of the of the one or more prediction entries.

Clause 7. The apparatus of any preceding clause, wherein for each prediction entry of the one or more prediction entries, the prediction confidence information comprises one or more counters indicative of utilisation of that prediction entry.

Clause 8. The apparatus of clause 7, wherein the one or more counters comprises a prediction hit counter indicative of a number of successful transaction requests resulting in retrieval of data subsequently forwarded to processing circuitry.

Clause 9. The apparatus of clause 8, wherein the prediction hit counter is a saturating counter.

Clause 10. The apparatus of any of clauses 7 to 9, wherein the one or more counters comprises a prediction counter identifying a number of transaction requests issued in response to hits on that prediction entry.

Clause 11. The apparatus of clause 10, wherein:
the prediction counter is a relative prediction counter, and the one or more counters comprises a relative success counter indicative of a relative number of successful transaction requests resulting in retrieval of data subsequently forwarded to processing circuitry; and
the prediction circuitry is responsive to saturation of the relative prediction counter to reduce both the relative success counter and the relative prediction counter by a same scaling factor.

Clause 12. The apparatus of any preceding clause, wherein the prediction circuitry is configured to maintain recursion depth information associated with the lookup and to increment the recursion depth information when triggering the one or more further lookups, and the recursive prediction condition is dependent on the recursion depth information.

Clause 13. The apparatus of clause 12, wherein the prediction circuitry is configured to:
identify a confidence threshold based on the recursion depth information; and
to determine that the recursive prediction condition is satisfied when the prediction confidence information is greater than or equal to the confidence threshold.

Clause 14. The apparatus of clause 13, wherein the confidence threshold is identified from at least one of:
an integer multiple of the depth information; and
a lookup table indexed using the depth information.

Clause 15. The apparatus of any preceding clause, comprising prefetch generation circuitry configured to generate, as the transaction request, a prefetch request to prefetch data into local storage circuitry in advance of a demand request for the data by processing circuitry.

Clause 16. The apparatus of any preceding clause, comprising branch prediction circuitry configured to issue the transaction request to an instruction prefetching queue to trigger a block of one or more instructions to be fetched into local instruction storage circuitry in anticipation of a flow of instructions requiring the block of one or more instructions.

Clause 17. A system comprising:
the apparatus of any preceding clause, implemented in at least one packaged chip;
at least one system component; and
a board,
wherein the at least one packaged chip and the at least one system component are assembled on the board.

Clause 18. A chip-containing product comprising the system of clause 17, wherein the system is assembled on a further board with at least one other product component.

Clause 19. A method comprising:
storing, in prediction storage circuitry, one or more prediction entries, each of the one or more prediction entries identified by a prediction identifier and comprising prediction information; and
in response to receipt of a given prediction identifier, performing a lookup in the prediction storage circuitry based on the given prediction identifier, and when the lookup results in a hit on a prediction entry of the one or more prediction entries:
   retrieving corresponding prediction information comprised in the prediction entry and triggering a transaction request based on the corresponding prediction information;
   performing a recursion procedure to determine whether the prediction information identifies one or more further prediction identifiers; and
   in response to the recursion procedure determining that the prediction information identifies one or more further prediction identifiers, triggering one or more further lookups in the prediction storage circuitry based on each of the one or more further prediction identifiers comprised in the prediction entry,
wherein:
each of the one or more prediction entries encodes prediction confidence information; and
the method comprises suppressing the recursion procedure when the prediction confidence information encoded in the prediction entry does not satisfy a recursive prediction condition.

Clause 20. A non-transitory computer-readable medium storing computer-readable code for fabrication of the apparatus of any preceding clause.

We claim:

1. An apparatus comprising:
prediction storage circuitry configured to store one or more prediction entries, each of the one or more prediction entries identified by a prediction identifier and comprising prediction information; and
prediction circuitry responsive to receipt of a given prediction identifier to perform a lookup in the prediction storage circuitry based on the given prediction identifier, wherein the prediction circuitry is configured, when the lookup results in a hit on a prediction entry of the one or more prediction entries:
to retrieve corresponding prediction information comprised in the prediction entry and to trigger a transaction request based on the corresponding prediction information;
to perform a recursion procedure to determine whether the prediction information identifies one or more further prediction identifiers; and
in response to the recursion procedure determining that the prediction information identifies one or more further prediction identifiers, to trigger one or more further lookups in the prediction storage circuitry based on each of the one or more further prediction identifiers comprised in the prediction entry, wherein:
each of the one or more prediction entries encodes prediction confidence information; and
the prediction circuitry is configured to suppress the recursion procedure when the prediction confidence information encoded in the prediction entry does not satisfy a recursive prediction condition.

2. The apparatus of claim 1, comprising storage circuitry configured to store data for processing by processing circuitry, wherein the transaction request is a request for data to be retrieved for storage in the storage circuitry.

3. The apparatus of claim 2, wherein the prediction circuitry is configured to trigger the storage circuitry to associate metadata with the data, the metadata indicative that the transaction request was triggered by the prediction circuitry.

4. The apparatus of claim 3, wherein the storage circuitry is responsive to a demand request for the data to perform a determination of whether the metadata is associated with the data, and when the determination identifies that the metadata is associated with the data, to signal a prediction usefulness indication to the prediction circuitry.

5. The apparatus of claim 4, wherein the storage circuitry is responsive to receipt of the demand request for the data to clear the metadata.

6. The apparatus of claim 1, wherein the prediction circuitry is responsive to receipt of an indication that the prediction comprised in one of the one or more prediction entries resulted in retrieval of data subsequently forwarded to processing circuitry, to update the prediction confidence information encoded in that one of the of the one or more prediction entries.

7. The apparatus of claim 1, wherein for each prediction entry of the one or more prediction entries, the prediction confidence information comprises one or more counters indicative of utilisation of that prediction entry.

8. The apparatus of claim 7, wherein the one or more counters comprises a prediction hit counter indicative of a number of successful transaction requests resulting in retrieval of data subsequently forwarded to processing circuitry.

9. The apparatus of claim 8, wherein the prediction hit counter is a saturating counter.

10. The apparatus of claim 7, wherein the one or more counters comprises a prediction counter identifying a number of transaction requests issued in response to hits on that prediction entry.

11. The apparatus of claim 10, wherein:
the prediction counter is a relative prediction counter, and the one or more counters comprises a relative success counter indicative of a relative number of successful transaction requests resulting in retrieval of data subsequently forwarded to processing circuitry; and
the prediction circuitry is responsive to saturation of the relative prediction counter to reduce both the relative success counter and the relative prediction counter by a same scaling factor.

12. The apparatus of claim 1, wherein the prediction circuitry is configured to maintain recursion depth information associated with the lookup and to increment the recursion depth information when triggering the one or more further lookups, and the recursive prediction condition is dependent on the recursion depth information.

13. The apparatus of claim 12, wherein the prediction circuitry is configured to:
identify a confidence threshold based on the recursion depth information; and
to determine that the recursive prediction condition is satisfied when the prediction confidence information is greater than or equal to the confidence threshold.

14. The apparatus of claim 13, wherein the confidence threshold is identified from at least one of:
an integer multiple of the depth information; and
a lookup table indexed using the depth information.

15. The apparatus of claim 1, comprising prefetch generation circuitry configured to generate, as the transaction request, a prefetch request to prefetch data into local storage circuitry in advance of a demand request for the data by processing circuitry.

16. The apparatus of claim 1, comprising branch prediction circuitry configured to issue the transaction request to an instruction prefetching queue to trigger a block of one or more instructions to be fetched into local instruction storage circuitry in anticipation of a flow of instructions requiring the block of one or more instructions.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
storing, in prediction storage circuitry, one or more prediction entries, each of the one or more prediction entries identified by a prediction identifier and comprising prediction information; and
in response to receipt of a given prediction identifier, performing a lookup in the prediction storage circuitry based on the given prediction identifier, and when the lookup results in a hit on a prediction entry of the one or more prediction entries:
retrieving corresponding prediction information comprised in the prediction entry and triggering a transaction request based on the corresponding prediction information;
performing a recursion procedure to determine whether the prediction information identifies one or more further prediction identifiers; and
in response to the recursion procedure determining that the prediction information identifies one or more further prediction identifiers, triggering one or more further lookups in the prediction storage circuitry based on each of the one or more further prediction identifiers comprised in the prediction entry,
wherein:
each of the one or more prediction entries encodes prediction confidence information; and
the method comprises suppressing the recursion procedure when the prediction confidence information encoded in the prediction entry does not satisfy a recursive prediction condition.

20. A non-transitory computer-readable medium storing computer-readable code for fabrication of an apparatus comprising:
prediction storage circuitry configured to store one or more prediction entries, each of the one or more prediction entries identified by a prediction identifier and comprising prediction information; and
prediction circuitry responsive to receipt of a given prediction identifier to perform a lookup in the prediction storage circuitry based on the given prediction identifier, wherein the prediction circuitry is configured, when the lookup results in a hit on a prediction entry of the one or more prediction entries:
to retrieve corresponding prediction information comprised in the prediction entry and to trigger a transaction request based on the corresponding prediction information;
to perform a recursion procedure to determine whether the prediction information identifies one or more further prediction identifiers; and
in response to the recursion procedure determining that the prediction information identifies one or more further prediction identifiers, to trigger one or more further lookups in the prediction storage circuitry based on each of the one or more further prediction identifiers comprised in the prediction entry,
wherein:
each of the one or more prediction entries encodes prediction confidence information; and
the prediction circuitry is configured to suppress the recursion procedure when the prediction confidence information encoded in the prediction entry does not satisfy a recursive prediction condition.
